(19) United States
(12) Patent Application Publication
(10) Pub. No.: US 2012/0012432 A1
(43) Pub. Date: Jan. 19, 2012

(54) Coupling Device, Testing Arrangement Outfitted Therewith, And Method For Coupling A Large Gear Unit To A Rotative Device

(75) Inventor: Peter MAYER, Diedforf (DE)

(73) Assignee: RENK Aktiengesellschaft, Augsburg (DE)

(21) Appl. No.: 13/028,894

(22) Filed: Feb. 16, 2011

(30) Foreign Application Priority Data
Feb. 17, 2010 (DE) 10 2010 002 059.1

(51) Int. Cl. F16D 11/10

(52) U.S. Cl. 192/69.8

(57) ABSTRACT

A coupling device for coupling a large gear unit to a rotative device has an inner sleeve rotatively coupleable to one of the large gear unit and the rotative device, and an outer sleeve rotatively coupleable to the other of the large gear unit and rotative device. An inner diameter of the outer sleeve can be fitted axially to an outer diameter of the inner sleeve. A first connection device connected to the inner sleeve terminates in a first coupling portion, and a second connection device connected to the outer sleeve terminates in a second coupling portion that is connectable to the first coupling portion. An actuator integrated in one of the first and second connection devices moves the associated connection arm axially. A testing arrangement is outfitted with the coupling device and performs a method of coupling the large gear unit to the rotative device.

### BACKGROUND OF THE INVENTION

1. Field of the Invention

The invention is directed to a coupling device for coupling a large gear unit to a rotative device, a testing device which is outfitted with a coupling device of this kind, and a method for coupling a large gear unit to a rotative device.

2. Description of the Related Art

Large gear units are used in wind power plants and in ships, for example. The large gear units installed in wind power plants, for example, should function reliably and without outages over a long period of time. In order to ensure a corresponding quality in the large gear units, they should undergo operating tests in which the running characteristics and stability of the large gear units are tested under conditions coming as close as possible to real-world conditions. In this way, defects can be detected quickly so that shipment of defective large gear units and costly repairs and/or replacement can be avoided.

Examples of testing arrangements developed for wind power plants are described in WO 2007/140788 A2 and EP 1 564 405 A1.

When testing large gear units, these large gear units can be connected, for example, to a drive such as an electric motor on the input side and/or to a load such as an electric generator on the output side. Drives and loads of this kind are referred to as rotative devices within the meaning of the invention.

For purposes of connecting a rotative device to the large gear unit, both assemblies must be precisely aligned with respect to one another and the driving shafts of these assemblies must be centered so as to be in exact alignment with one another. In the prior art, large gear units and rotative devices are aligned with one another, e.g., by hoists. Owing to the large masses to be moved (a large gear unit of this type weighs approximately 60 tons or more), this alignment can be very laborious and tedious.

### SUMMARY OF THE INVENTION

It is an object of the invention to provide a coupling device for coupling a large gear unit to a rotative device, wherein the coupling device makes it possible to align the large gear unit and the rotative device with respect to one another in a fast, simple and precise manner. The invention has a further object of providing a testing arrangement which is outfitted with a coupling device of this kind for testing a large gear unit and a method for coupling a large gear unit to a rotative device using a coupling device of this kind.

According to a first aspect of the invention, a coupling device is provided for coupling a large gear unit to a rotative device, wherein the coupling device has an inner sleeve or internal sleeve having an axial end which forms a first coupling side and which can be rotatively coupled to one of the assemblies comprising large gear unit and rotative device and having an outer diameter, an outer sleeve or outside sleeve having an axial end which forms a second coupling side and which can be rotatively coupled to the other one of the respective assemblies comprising large gear unit and rotative device and having an inner diameter so that the inner diameter of the outer sleeve can be fitted axially to the outer diameter of the inner sleeve, a first connection device having a first connection arm which is connected on the first coupling side to the inner sleeve and which extends therefrom axially through the inner sleeve so as to terminate in a first coupling portion, a second connection device having a second connection arm which is connected on the second coupling side to the outer sleeve and which extends therefrom axially through the outer sleeve so as to terminate in a second coupling portion which can be coupled to the first coupling portion, and an actuator which is integrated in one of either the first connection device or the second connection device in such a way that the associated connection arm is movable axially in the associated sleeve.

Owing to the fact that the first coupling portion and second coupling portion can be coupled to one another and that one of the connection arms is movable axially in the associated sleeve by means of the actuator, the large gear unit and the rotative device, or the inner sleeve and outer sleeve, can be moved toward one another axially. Because the inner diameter of the outer sleeve can be fitted axially to the outer diameter of the inner sleeve, both sleeves and, therefore, the large gear unit and the rotative device can be centered so as to be aligned with one another in an exact fit. As a result, the coupling device allows the large gear unit and the rotative device to be aligned with respect to one another in a fast, simple and precise manner. Further, the coupling device according to the invention also allows the large gear unit and rotative device to be pushed apart and separated from one another in a fast and simple manner after the large gear unit has been tested.

According to an embodiment of the invention, the outer diameter of the inner sleeve and the inner diameter of the outer sleeve are constructed conically or cylindrically so that the inner diameter of the outer sleeve can be fitted axially to the outer diameter of the inner sleeve in a centered manner.

In particular, when the inner diameter and outer diameter are constructed conically, a fast, simple and precise alignment of the large gear unit and rotative device with respect to one another can be achieved after a relatively rough pre-alignment. This is also achieved when the inner diameter and outer diameter are constructed cylindrically, but a somewhat more precise pre-alignment of the large gear unit and rotative device may be necessary in this case.

According to another embodiment of the invention, the large gear unit is a wind power plant gear unit. According to yet another embodiment of the invention, the rotative device is a drive, particularly a large electric motor preferably weighing multiple tons, and/or a load, particularly an electric generator preferably weighing multiple tons.

According to a further embodiment of the coupling device according to the invention, a clamping device is arranged on an outer diameter of the outer sleeve, the clamping device being operative to tightly clamp the inner diameter of the outer sleeve with surface bearing pressure on the outer diameter of the inner sleeve so that a predetermined torque can be transmitted between the outer sleeve and inner sleeve.

Owing to this construction of the coupling device according to the invention, this coupling device can be used not only to align the large gear unit and rotative device relative to one another but also to transmit torque between the large gear unit and the rotative device. This saves additional coupling means and additional setup time.

In another embodiment of the coupling device according to the invention, this coupling device also has a bearing block which is to be fastened to a base and which rotatably supports the inner sleeve from the radially outer side by a rotational bearing device.

As a result of this construction of the coupling device according to the invention, the dead load of the coupling device can be absorbed on the one hand and rotational vibrations during transmission of torque between the large gear unit and the rotative device can be absorbed on the other hand. Accordingly, in the coupled state, the large gear unit and the rotative device are relieved of the dead load of the coupling device and the introduction of rotational vibrations into the large gear unit is reduced, minimized or prevented.

In one embodiment of the coupling device according to the invention, the rotational bearing device has a spherical roller bearing. According to an embodiment of the invention, the base is a foundation and/or a framework.

In another embodiment of the coupling device according to the invention, the length of the connection arm of the one of the first and second connection devices that does not have the actuator is so dimensioned that at least its associated coupling portion projects axially out of the associated sleeve.

As a result of this construction of the coupling device according to the invention, the coupling portion projecting axially from the associated sleeve is particularly easily accessible from the outside, and the two coupling portions of the first connection device and second connection device can be coupled to one another and uncoupled from one another in a particularly simple and fast manner. This saves further setup time.

In yet another embodiment of the coupling device according to the invention, the actuator has a working member which is movable axially, wherein the connection arm is formed by the working member of the actuator in the connection device which is provided with the actuator.

As a result of this construction of the coupling device according to the invention, the actuator is integrated in the respective connection device so as to economize on space and material.

In an embodiment of the coupling device according to the invention, the actuator is a fluid cylinder, particularly a hydraulic cylinder. In this case, a working member is preferably formed by the piston rod of the fluid cylinder. In other embodiment forms of the coupling device according to the invention, the actuator can also be formed by a gear motor and/or a spindle drive arrangement. According to yet another embodiment form of the coupling device according to the invention, the connection arm which is integrated in the actuator can have a toothing (e.g., such as a toothed rack) and can be guided in an axial guide.

In yet another embodiment of the coupling device according to the invention, the actuator is integrated in the first connection device, wherein the coupling portion of the first connection arm is slidingly guided at an inner diameter of the inner sleeve.

The functionality of the coupling device according to the invention is improved in a simple manner by the sliding guiding of the coupling portion in the inner sleeve.

According to a second aspect of the invention, a testing arrangement for a large gear unit is provided. The testing arrangement has a coupling device according to one or more or all of the embodiment forms of the invention described above in any conceivable combination, a large gear unit to be tested, which large gear unit is rotatively coupled to one of either the inner sleeve or the outer sleeve at its axial end forming a coupling side, a rotative device which is rotatively coupled to the other one of either the inner sleeve or outer sleeve at its axial end forming a coupling side, wherein the first coupling portion of the first connection arm of the first connection device is coupled to the second coupling portion of the second connection arm of the second connection device, wherein the inner diameter of the outer sleeve is fitted axially to the outer diameter of the inner sleeve by a preceding axial movement of the connection arm of the connection device provided with the actuator.

As a result of the fact that the first coupling portion and second coupling portion are coupled to one another and the inner diameter of the outer sleeve is fitted axially to the outer diameter of the inner sleeve by a preceding axial movement of the connection arm of the connection device provided with the actuator, both sleeves and, therefore, the large gear unit and the rotative device are centered in alignment with respect to one another in a simple, fast and exactly fitting manner.

In an embodiment of the testing arrangement according to the invention, the large gear unit is a wind power plant gear unit. In another embodiment of the testing arrangement according to the invention, the rotative device is a drive, particularly a large electric motor preferably weighing multiple tons, and/or a load, particularly an electric generator preferably weighing multiple tons.

In yet another embodiment of the testing arrangement according to the invention, the clamping device is clamped on the outer diameter of the outer sleeve so that the inner diameter of the outer sleeve is tightly clamped with surface bearing pressure on the outer diameter of the inner sleeve and a predetermined torque can accordingly be transmitted between the outer sleeve and inner sleeve.

Owing to this construction of the coupling device according to the invention, this coupling device can be used not only to align the large gear unit and rotative device relative to one another but also to transmit torque between the large gear unit and the rotative device. This saves additional coupling means and additional setup time.

According to a third aspect of the invention, a method is provided for coupling a large gear unit to a rotative device. The method comprises providing a coupling device according to one or more or all of the embodiment forms of the invention described above in any conceivable combination, providing a large gear unit and rotative coupling thereof to one of either the inner sleeve or the outer sleeve at its axial end forming a coupling side, providing a rotative device and rotative coupling thereof to the other one of either the inner sleeve or outer sleeve at its axial end forming a coupling side, coupling of the first coupling portion of the first connection arm of the first connection device to the second coupling portion of the second connection arm of the second connection device, and actuating the actuator so that the inner diameter of the outer sleeve is fitted axially to the outer diameter of the inner sleeve by an axial movement of the connection arm of the connection device provided with the actuator.

As a result of the fact that the first coupling portion and second coupling portion are coupled to one another and with each actuation of the actuator and, therefore, with each axial movement of the connection arm of the connection device provided with the actuator, the inner diameter of the outer sleeve is fitted axially to the outer diameter of the inner sleeve, both sleeves and, therefore, the large gear unit and the rotative device are centered in alignment with respect to one another in a simple, fast and exactly fitting manner. Further, the method according to the invention also allows the large gear unit and rotative device to be pushed apart and separated from one another in a fast and simple manner after the large gear unit has been tested.

In an embodiment of the method according to the invention, the large gear unit is a wind power plant gear unit. In another embodiment of the method according to the invention, the rotative device is a drive, particularly a large electric motor preferably weighing multiple tons, and/or a load, particularly an electric generator preferably weighing multiple tons.

In another embodiment of the method according to the invention, the clamping device is clamped on the outer diameter of the outer sleeve so that the inner diameter of the outer sleeve is tightly clamped with surface bearing pressure on the outer diameter of the inner sleeve and a predetermined torque can accordingly be transmitted between the outer sleeve and inner sleeve.

Owing to this structuring of the method according to the invention, this method achieves not only an alignment of the large gear unit and rotative device relative to one another but also achieves a connection between the large gear unit and the rotative device suitable for transmitting a desired or defined torque. This saves additional coupling means and additional setup time.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be described in more detail in the following based on preferred embodiment forms and with reference to the accompanying drawings.

FIG. 1 is a longitudinal sectional view through a testing arrangement for a large gear unit, which testing arrangement is outfitted with a coupling device according to an embodiment of the invention; and

FIG. 2 is a flow chart illustrating an method according to the invention.

### DETAILED DESCRIPTION OF THE PRESENTLY PREFERRED EMBODIMENTS

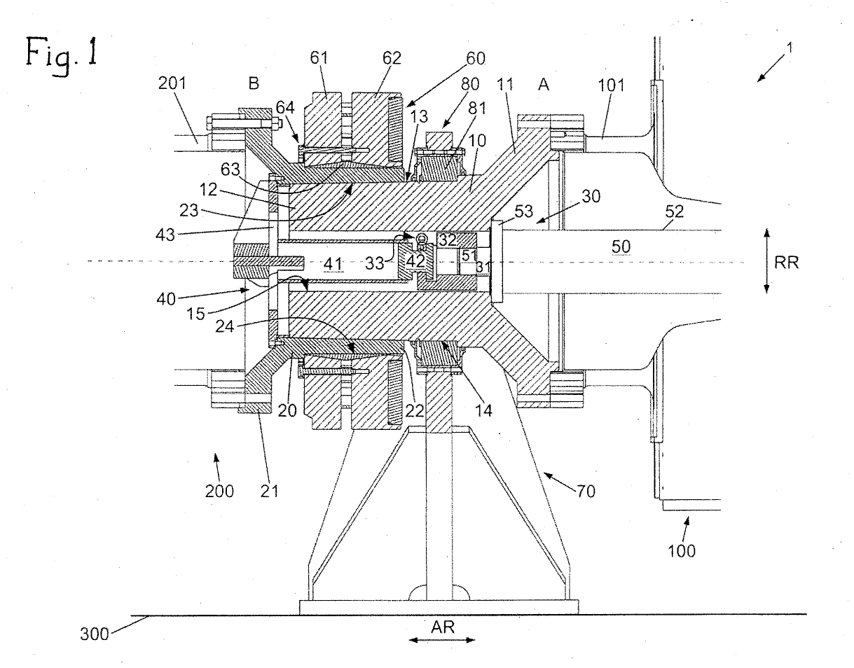

As is shown in FIG. 1, a testing arrangement for a large gear unit according to an embodiment of the invention has a coupling device 1, a large gear unit 200 (only suggested in FIG. 1) which is to be tested and which is constructed in this instance as a wind power plant gear unit, and a rotative device 100 (only suggested in FIG. 1) constructed in this instance as a drive for the large gear unit 200 in the form of an electric motor weighing multiple tons.

An axial direction AR and a radial direction RR are defined for the testing arrangement for the following description of the invention as is shown in FIG. 1.

The coupling device 1 has an inner sleeve or inside sleeve 10, an outer sleeve or outside sleeve 20, a first connection device 30, a second connection device 40, an actuator 50 constructed in this instance as a hydraulic cylinder, a clamping device 60, and a bearing block 70.

The inner sleeve 10 has an axial end 11 which is shaped as a Y-shaped or funnel-shaped flange and which forms a first coupling side A, this axial end 11 being rotatively coupled to a hollow-shaft-shaped output shaft train 101 of the rotative device 100. The inner sleeve 10 further has a length area with a conical outer diameter 13 proceeding from its other axial end 12.

The bearing block 70 which is fastened to a base 300 (such as is described, e.g., in WO 2007/140788 A2) which is shaped like a metal frame and which can be adjusted, if necessary, at an inclination to the horizontal rotatably supports the inner sleeve 10 from the radially outer side at a length area of the inner sleeve 10 having a cylindrical outer diameter 14 by a rotational bearing device 80 which is outfitted with a spherical roller bearing 81.

The outer sleeve 20 has an axial end 21 which is shaped as a Y-shaped or funnel-shaped flange and which forms a second coupling side B, this axial end 21 being rotatively coupled to a hollow-shaft-shaped input shaft train 201 of the large gear unit 200. The outer sleeve 20 also has a conical inner diameter 23 continuously from one axial end 21 to its other axial end 22 so that the conical inner diameter 23 of the outer sleeve 20 can be fitted axially to the conical outer diameter 13 of the inner sleeve 10 as is realized in the manner shown in FIG. 1.

The clamping device 60 is disposed on a length area with a cylindrical outer diameter 24 of the outer sleeve 20 and is arranged in such a way that the conical inner diameter 23 of the outer sleeve 20 can be tightly clamped by the clamping device 60 by surface bearing pressure on the conical outer diameter 13 of the inner sleeve 10 (as is realized in the manner shown in FIG. 1) so that a predetermined torque can be transmitted between the outer sleeve 20 and the inner sleeve 10 for driving the large gear unit 100 for testing purposes.

The clamping device 60 has two annular clamping jaws 61, 62, each having a conical inner diameter which is adapted to a clamping sleeve 63 whose outer diameter is adapted in a roof-shaped or double-conical manner to the cylindrical outer diameter 24 of the outer sleeve 20. The two clamping jaws 61, 62 can be drawn toward one another on both sides of the clamping sleeve 63 by a screw connection 64 so that a force that is directed radially inward is exerted on the outer sleeve 20 by the wedge effect which is accordingly created so that this outer sleeve 20 is tightly clamped to the inner sleeve 10.

The first connection device 30 has a first connection arm 31 which is connected on the first coupling side A to the inner sleeve 10 and which extends axially therefrom through the inner sleeve 10 so as to terminate in a first coupling portion 32.

More precisely stated, the actuator 50 in this embodiment form of the invention has an axially displaceable working member 51, and the connection arm 31 in the first connection device 30 which is provided with the actuator 50 is formed by the working member 51 of the actuator 50. According to this embodiment form of the invention, the actuator 50 is formed by a hydraulic cylinder and the working member 51 is formed by the piston rod of the hydraulic cylinder. The coupling portion 32 of the first connection arm 31 (or of the working member 51) is slidingly guided at an inner diameter 15 of the inner sleeve 10 for axial displacement.

The actuator 50 further has a housing 52 with a fastening flange 53. The fastening flange 53 is supported at the inside of the inner sleeve 10 and fastened to it on the first coupling side A.

Finally, the actuator 50 is integrated in the first connection device in such a way that the associated first connection arm 31 and, therefore, also its first coupling portion 32 are movable axially in the associated inner sleeve 10.

The second connection device 40 has a second connection arm 41 which is connected on the second coupling side B to the outer sleeve 20 on the inner side by a disk-shaped connection flange 43 and which extends axially therefrom through the outer sleeve 20 so as to terminate in a second coupling portion 42 which can be coupled (and is coupled in FIG. 1) to the first coupling portion 32. As can be seen from FIG. 1, the first coupling portion 32 and the second coupling portion 42 can be coupled to one another and uncoupled from one another quickly and simply by means of a quick-acting closure 33.

As can be seen from FIG. 1, the length of the second connection arm 41 of the second connection device 40 not having the actuator is so dimensioned that at least its associated second coupling portion 42 projects axially from the associated outer sleeve 20. Therefore, the second coupling portion 42 is easily accessible from the outside when the outer sleeve 20 and the inner sleeve 10 are still separated so as to allow the two coupling portions 32, 42 of the first connection device 30 and second connection device 40 to be coupled to one another and uncoupled from one another in a simple and fast manner.

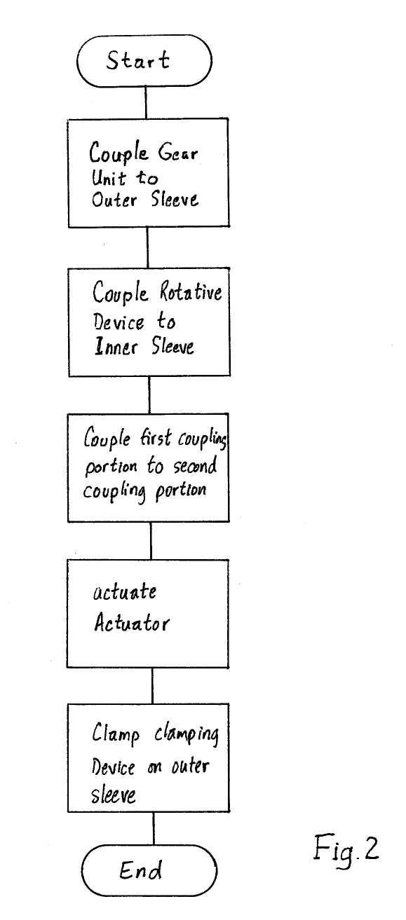

A method for coupling the large gear unit 200 to the rotative device 100 according to an embodiment form of the invention will be described in the following with reference to FIG. 2.

In the method according to the invention, a coupling device 1 according to the invention and the large gear unit 200 are set down on the base 300, preferably using a hoist, and the large gear unit 200 is rotatively coupled to the outer sleeve 20 by its input shaft train 201 at the Y-shaped axial end 21 of the outer sleeve 20 forming the second coupling side B, step S100. The large gear unit 200 is then fixed on the base 300 by fasteners, e.g., screws.

Further in the method according to the invention, the rotative device 100 is set down on the base 300, preferably using a hoist, and this rotative device 100 is rotatively coupled to the inner sleeve 10 by its output shaft train 101 at the Y-shaped axial end 11 of the inner sleeve 10 forming the first coupling side A, step S200. The working member 51 (first connection arm 31) of the actuator 50 is then possibly moved out so that the first coupling portion 32 projects axially from the axial end 12 of the inner sleeve 10 located opposite the Y-shaped axial end 11 forming the first coupling side A.

It should be noted that the large gear unit 200 and the rotative device 100 are arranged on the base 300, possibly on a bed, in such a way that the input shaft train 201 and the output shaft train 101 are located at the same height in radial direction RR, i.e., have the same peak height. Further, the rotative device 100 is arranged on the base 300, possibly using sliding means, in such a way that the rotative device 100 is displaceable axially on the base 300.

When placing the rotative device 100, which is preferably carried out by means of a hoist, the second coupling portion 42 of the second connection arm 41 of the second connection device 40 is preferably coupled to the extended first coupling portion 32 of the first connection arm 31 (working member 51 of the actuator 50) of the first connection device 30 by means of the quick-acting closure 33, step S300. In so doing, the outer sleeve 20 and the inner sleeve 10 are roughly aligned with respect to one another at the same time so that it is possible to fit them to one another.

When the rotative device 100 is located on the base 300, the actuator 50 is actuated so that the conical inner diameter 23 of the outer sleeve 20 is fitted axially to the conical outer diameter 13 of the inner sleeve 10 by axial displacement of the first connection arm 31 (working member 51) of the first connection device 30 which is provided with the actuator 50, step S400.

In this way, the rotative device 100 is drawn axially toward the large gear unit 200 and oriented in alignment with the large gear unit 200 so as to be centered by the centering effect of the conicity of the inner sleeve 10 and outer sleeve 20. If necessary, the pulling of the rotative device 100 can be assisted by slightly raising the rotative device 100 (reducing the surface bearing pressure between the rotative device 100 and base 300) by means of a hoist. After centering has been achieved, the rotative device 100 is fixed on the base 300 by fasteners, e.g., screws.

Further, the clamping device 60 is then clamped on the cylindrical outer diameter 24 of the outer sleeve 20 by tightening the screw connection 64 so that the conical inner diameter 23 of the outer sleeve 20 is tightly clamped with surface bearing pressure on the conical outer diameter 13 of the inner sleeve 10, and a predetermined torque can therefore be transmitted between the outer sleeve 20 and the inner sleeve 10, step S500.

The large gear unit 200 can now be driven and its running characteristics tested by operating the rotative device 100 which is constructed in this instance as an electric motor.

Of course, in addition or alternatively according to an embodiment form of the invention not shown in the drawing, a rotative device in the form of a load (e.g., an electric generator) could also be coupled to an output shaft train (not shown) of the large gear unit 200 by means of a—possibly additional—coupling device 1.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A coupling device for coupling a large gear unit to a rotative device, the coupling device comprising:
an inner sleeve having an axial end forming a first coupling side, which can be rotatively coupled to one of the large gear unit and the rotative device, and an outer diameter;
an outer sleeve having an axial end forming a second coupling side, which can be rotatively coupled to the other one of the large gear unit and the rotative device, and an inner diameter arranged and dimensioned so that the inner diameter of the outer sleeve can be fitted axially to the outer diameter of the inner sleeve;
a first connection device having a first connection arm connected on the first coupling side to the inner sleeve and which extends axially therefrom through the inner sleeve and terminates in a first coupling portion;
a second connection device having a second connection arm connected on the second coupling side to the outer sleeve and which extends axially therefrom through the outer sleeve and terminates in a second coupling portion that is couplable to the first coupling portion; and
an actuator integrated in one of the first and second connection devices such that one of the first and second connection arms associated with the one of the first and second connection devices having the actuator is movable axially in the associated one of the inner and outer sleeves.

2. The coupling device of claim 1, wherein the outer diameter of the inner sleeve and the inner diameter of the outer sleeve are constructed conically or cylindrically so that the inner diameter of the outer sleeve can be fitted axially to the outer diameter of the inner sleeve and simultaneously centered relative thereto.

3. The coupling device of claim 1, further comprising a clamping device arranged on an outer diameter of the outer sleeve, the clamping device operable to clamp the inner diameter of the outer sleeve with surface bearing pressure on the outer diameter of the inner sleeve so that a predetermined torque can be transmitted between the outer sleeve and inner sleeve.

4. The coupling device of claim 1, further comprising a bearing block fastenable to a base and a rotational bearing device, wherein the bearing block rotatably supports the inner sleeve from the radially outer side by the rotational bearing device.

5. The coupling device of claim 1, wherein a length of the connection arm of the other of the first and second connection devices not having the actuator is arranged and dimensioned such that at least an associated one of the first and second coupling portions projects axially out of the associated one of the inner sleeve and the outer sleeve.

6. The coupling device of claim 1, wherein the actuator includes a working member that is movable axially, and wherein the one of the first and second connection arms associated with the one of the first and second connection devices that includes the actuator is formed by the working member of the actuator.

7. The coupling device of claim 1, wherein the actuator is integrated in the first connection device, and the first coupling portion of the first connection arm is slidingly guided at an inner diameter of the inner sleeve.

8. A testing arrangement for a large gear unit including the coupling device of claim 1, a large gear unit to be tested, the large gear unit being rotatively coupled to one of the first and second coupling sides of the inner sleeve and the outer sleeve, a rotative device rotatively coupled to the other one of first and second coupling sides of the inner sleeve and the outer sleeve, wherein the first coupling portion of the first connection arm of the first connection device is coupled to the second coupling portion of the second connection arm of the second connection device, and the inner diameter of the outer sleeve is fitted axially to the outer diameter of the inner sleeve by an axial movement of the one of the first and second connection arms associated with the one of the first and second connection devices having the actuator.

9. The testing arrangement of claim 8, wherein a clamping device is clamped on an outer diameter of the outer sleeve so that the inner diameter of the outer sleeve is tightly clamped with surface bearing pressure on the outer diameter of the inner sleeve and a predetermined torque can accordingly be transmitted between the outer sleeve and the inner sleeve.

10. A method for coupling a large gear unit to a rotative device, comprising:
providing a coupling device according to claim 1;
providing a large gear unit and rotative coupling of the large gear unit to one of one of the first coupling side of the inner sleeve and the second coupling side of the outer sleeve,
providing a rotative device and rotative coupling of the rotative device to the other one of the first and second coupling sides;
coupling the first coupling portion of the first connection arm of the first connection device to the second coupling portion of the second connection arm of the second connection device; and
actuating the actuator so that the inner diameter of the outer sleeve is fitted axially to the outer diameter of the inner sleeve by an axial movement of the one of the first and second connection arms associated with the one of the first and second connection devices having the actuator.

11. The method of claim 10, further comprising clamping a clamping device on an outer diameter of the outer sleeve so that the inner diameter of the outer sleeve is tightly clamped with surface bearing pressure on the outer diameter of the inner sleeve and a predetermined torque can accordingly be transmitted between the outer sleeve and the inner sleeve.
